(19) United States
(12) Patent Application Publication
(10) Pub. No.: US 2008/0183766 A1
(43) Pub. Date: Jul. 31, 2008

(54) METHODS AND SYSTEMS FOR INDUCTIVE DATA TRANSFORMATION

(76) Inventors: David W. Weston, Castle Rock, CO (US); Navin V. Kurani, Highlands Ranch, CO (US)

Correspondence Address: JOHN S. BEULICK (24691);ARMSTRONG TEASDALE LLP, ONE METROPOLITAN SQUARE, SUITE 2600, ST. LOUIS, MO, 63102-2740, US

(21) Appl. No.: 11/838,531

(22) Filed: Aug. 14, 2007

Related U.S. Application Data
(60) Provisional application No. 60/898,597, filed on Jan. 31, 2007.

(51) Int. Cl. G06F 17/30; G06F 17/00

(52) U.S. Cl. 707/200; 715/220; 707/E17.005

(57) ABSTRACT

A method for updating data within a database is described. The method includes identifying data elements within the database that need to be updated, creating a data transformation matrix for analysis of changes to the data elements, creating a database update script including an update command for each group of changes, and running the database update script to update the database.

### CROSS REFERENCE TO RELATED APPLICATIONS

This application claims the benefit of U.S. Provisional Patent Application No. 60/898,597, filed Jan. 31, 2007, which is hereby incorporated by reference in its entirety.

### BACKGROUND OF THE INVENTION

This invention relates generally to maintenance of database entries, and more specifically, to methods and systems for inductive data transformation.

Today's corporate databases often require one-time data changes to fix data issues. Data issues can take on many forms, for example, the owners of the data may discover problems with how data is being populated after a programming change is deployed, or data may need to be updated to account for changes made to the database schema or the introduction of new business rules. Situations requiring data fixes are also encountered as data is moved from a legacy system to a new database, or as databases are combined. The time after a data consolidation may provide many such opportunities for one-time data adjustments as data problems are discovered.

The problem with fixing most data problems is that it requires both analysis and programming to fix, and that means assigning programmers to the task, writing the code, testing the code, running the code, and then throwing away the code. The programming required for data fixes can be an especially difficult task if many special cases have to be accounted for, and time is usually a factor. If it is discovered that the fix program has an error or “hole” therein, it is possible that the so called fix to the database could result in problems that are worse than the original database issue.

### SUMMARY

In one aspect, a method for updating data within a database is provided. The method includes identifying data elements within the database that need to be updated, creating a data transformation matrix for analysis of changes to the data elements, creating a database update script including an update command for each group of changes, and running the database update script to update the database.

In another aspect, a computer is provided that is programmed to compile a matrix of proposed changes to data elements of a database, create a database update script, directly from data within the database, including an update command for each group of proposed changes, and run the database update script to update the data elements in the database.

In another aspect, a method for generating a script for updating data within a database is provided. The method includes manipulating elements within a spreadsheet associated with the database to create a data transformation matrix, creating, directly from data within the spreadsheet, a structured query language (SQL) data update command for updating the data within the database, and executing the SQL data update command.

### BRIEF DESCRIPTION OF THE DRAWINGS

FIG. 1 is a block diagram of a computer system.

FIG. 2 is a flowchart illustrating an inductive data transformation method.

### DETAILED DESCRIPTION

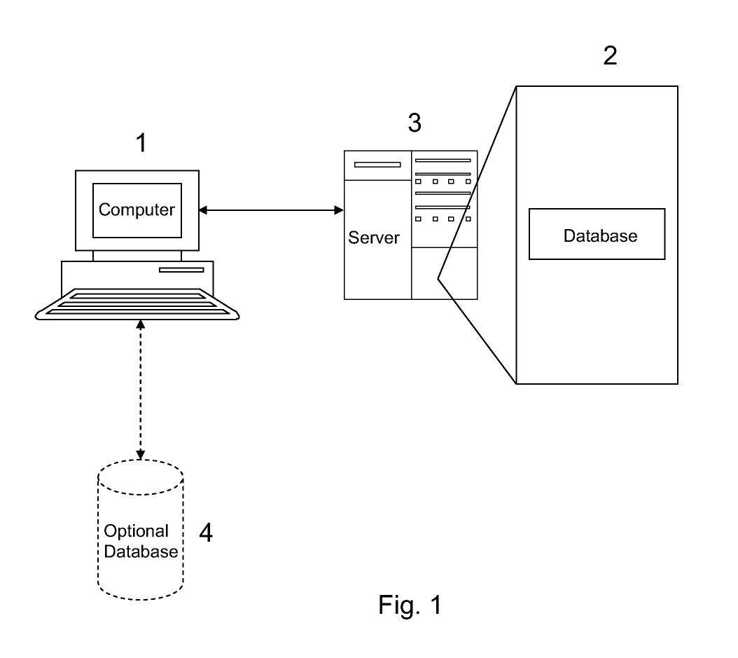

The methods and systems for inductive data transformation described herein provide a quick, structured, verifiable, and reversible method of analyzing, managing, and implementing a data and/or a database update process through the use of easily accessible spreadsheet software running on a computer, for example, computer system 1 as illustrated in FIG. 1. When confronted with a proposed data change, the methods and systems make it relatively simple for a data owner to understand the changes to the data, and what additional changes may result from the data change. This allows for validation of the data changes prior to the implementation of the data changes. In one embodiment, the described method automatically produces precision database update statements that can be run on any that includes a structured query language (SQL) compliant database, for example, database2, without preparation of an executable computer program.

Specifically, the method for inductive data transformation includes data investigation, data analysis, and implementation. Data investigation includes identifying the nature of the data changes required, a type of data associated with the changes, and categorizing the data changes. Data analysis includes determining the material changes to be made for each change category, including any change audit record management. Implementation includes generation of the SQL scripts that will be utilized in carrying out the data changes. As such, the inductive data transformation method allows changes made to a spreadsheet to transform the data within a database.

In one embodiment, the described inductive data transformation is a method, implemented on computer system 1, for making precision database changes without having to write what is sometimes referred to as a “load program”. Various embodiments of the method employ a common spreadsheet software package that is readily available to most computer users. In a specific embodiment, the software package utilized is Microsoft Excel (both Microsoft and Excel are trademarks of Microsoft Corporation, Redmond, Wash.) and the inductive data transformation method leverages well-formed Excel formulas to create the desired changes that are based on the data in the spreadsheet. In the embodiment, a formula is applied to affect a single change at a time, and the formula is reused, which allows the spreadsheet software to automatically correct the problems associated with the data.

Referring specifically to Figure, computer 1 is typically a user computer which is connected to a server 3 through an internet or other network connection which provides access to database 2. Alternatively, and as illustrated by the dashed lines, computer 1 may directly access a database 4, which is either internal or external to computer 1

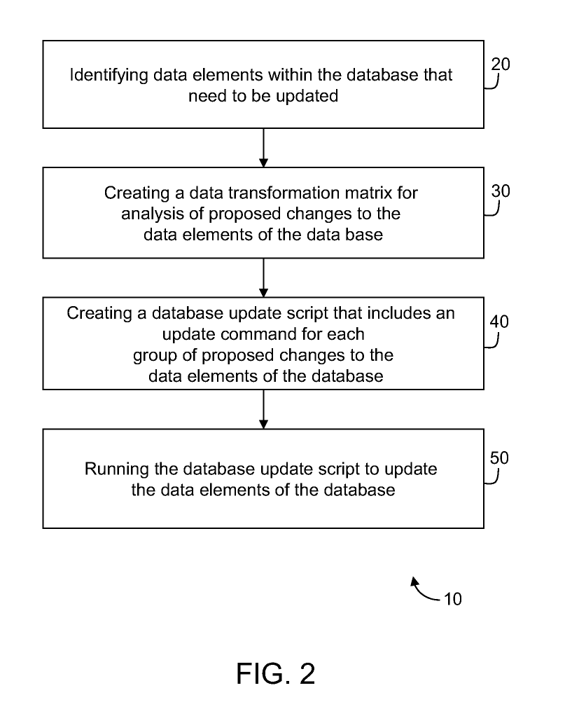

As illustrated in FIG. 2, which is a flowchart 10 of an inductive data transformation method, such process includes an investigation step that involves inspecting the data in question and determining the nature of the data issue, specifically, identifying 20 data elements within the database that need to be updated. Once the offending items are identified 20, the pertinent related data from the database (such as primary keys and the data columns in need of change—one row per primary key) is imported into the spreadsheet program and further analyzed to categorize the corrections required for each case. An analysis step of the inductive data transformation process is supported using sorting, searching and filtering capabilities built into the spreadsheet program. An example of such an analysis step is creating 30 a data transformation matrix for analysis of proposed changes to the data elements of the database. Verification of the intended data changes is relatively simple because the spreadsheet containing the data, the categories of correction, and the corrections themselves (down to the record level) are easily shared, inspected and confirmed by the data owner.

Finally, the change is implemented by creating a specially-created formula in the spreadsheet program that combines primary components and the data changes formatted as a SQL statement. With respect to FIG. 2, a database update script, or formula, is created 40 that includes an update command for each group of proposed changes to the data elements of the database. With a properly formatted formula having been created 40, and referring to an embodiment which utilizes Excel, utilization of a “fill down” command results in the creation of precision database update statements, ready to run as an SQL script. Therefore, each individual change is individually created, changeable, independently verifiable, and reversible. The method illustrated by flowchart 10 is then completed by running 50 the database update script to update the data elements of the database.

One key to the above described method is the how the spreadsheet is managed. In an embodiment, three areas are created within the spreadsheet in order to manage the work: a User-data area (where any subject-matter expert can easily understand, enter or correct information—containing any existing data and the data as the user wants it), a transformation area (where the analyst identifies the database columns and related columns that require populating and define the formulas to form the data), and the SQL area (which is where the SQL is derived from the data in the previous section). In one embodiment, the SQL area also contains an “undo” area. The undo area reduces risk by allowing any or all changes to the database to be reversed. Typically, changes to a database that are affected by the running of a load program are not reversible, absent preparation of another load program.

Management of the spreadsheet is taken into consideration with the inductive data transformation method. For example, large spreadsheets with multiple formulas therein may take considerable time for recalculation. To overcome any calculation time issues, an interface for user-supplied data is separately viewable so that the user can inspect, review, change and verify their data prior to the data transfer. Additionally, inductive data transformation employs a technique to capture a formula for a spreadsheet column within a note filed of that column so that the column data can be “locked” (using copy/paste special values) to eliminate any recalculating while still preserving the formulas.

In one configuration, three basic types of data changes are supported by the inductive data transformation method, including: simple fixes and adjustments, such as single-table insertions, deletions, and updates; complex fixes and adjustments, such as, multiple related table insertions, deletions and updates; and complex moves of data from a foreign source, an example of which would be moving Access (Access is a trademark of Microsoft Corporation, Redmond, Wash.) data into an Oracle database (Oracle is a trademark of Oracle Corporation, Redwood Shores, Calif.).

With regard to simple fixes, every type of fix begins by understanding the nature of the problem. In many cases a user will notice an unusual situation and bring it to the attention of a data analyst. The communication from the user usually takes the form of a complaint. As utilized herein, a simple fix refers to an analysis and correction that affects a single table.

An example of a complex fix scenario is described below. Specifically, an engineering data user reports that there is a software malfunction because two different engineering databases have different ways to indicate the units for voltage: the database for one system uses “VDC” and the database for the other system uses “V”, “Volt”, “VDC” and “DCV”. While from a high level this might appear to be a simple fix, for example, an inexperienced analyst might identify this as a simple single-table adjustment and jump right in and straighten out the second system using a SQL statement such as:

```
Update MEASUREMENTS_TABLE set UNIT = ‘VDC’
        where UNIT = ‘V’
        or UNIT = ‘Volt’
        or UNIT = ‘VDC’
        or UNIT = ‘DCV’;
```

However there are several problems with this seemingly straightforward solution.

UNIT is a foreign key to the Units table, therefore referencing data should be changed first. This example is referred to as a complex fix as it involves more than one table. Therefore, the order of the changes has to be considered so that any databases referential integrity rules are not violated. Although from an information point of view having a unit ID and a Unit Name would be the correct solution, this example simply illustrates the technique's advantages in the described situation. For example, the solution described above is not specific. Additionally, there is no way to know which rows in the database have been updated. Typically, the only feedback a user would receive is a final count of the number of rows affected. An additional problem is that the solution does not allow for easy correction. For example, if it is later discovered that the “Volt” unit in the second database actually represented “Volts AC” (a new unit), there is no easy way to fix the mistake.

An additional problem in the above scenario is that there is no accountability. Most databases have an audit table to account for changes to tables such as these. However, a single-statement SQL solution makes no attempt to account for the individual changes, so the change record is lost. Finally, the larger picture has not been accounted for, for example, are there other engineering units like these that are mismatched? A more comprehensive solution should consolidate the engineering units that match in both places.

One solution might be to keep these units in a single database table and share the table throughout the information system. However, a basic rule of information systems is that if the same data exists in more than one place, it's no longer the same data. A best practice would be to apply the analysis techniques and update methods towards consolidation of the tables, not just to making the data in both tables match. However, the example is additionally utilized herein to illustrate the inductive data transformation method.

More specifically, the inductive data transformation method and system overcomes the problems described above, and provides a more complete solution with less risk, and can be done very quickly. With regard to an investigation step, an analyst utilizing the inductive data transformation process first observes that if the voltage units are exhibiting problems, then perhaps there are other units that exhibit similar problems. An example raw table data is illustrated in Table 1.

TABLE 1
Engineering Units data in the divergent databases

| | DATABASE 1 | | | DATABASE 2 | |
|---|---|---|---|---|---|
| Key | Measurement | Units | Key | Measurement | Units |
| 1001 | Bulb1 Current | A | 2001 | Actuator2 Volts | V |
| 1002 | Bulb1 Voltage | VDC | 2002 | Actuator2 Current | AMPS |
| 1003 | Bulb1 Wattage | WATTS | 2003 | Actuator2 Temp | Deg F |
| 1004 | Bulb1 | DEGC | 2004 | Actuator3 Volts | DVC |
| | Temperature | | | | |
| 1005 | Tank1 Pressure | PSIG | 2005 | Actuator3 Current | AMPS |
| 1006 | Tank1 | DEGF | 2006 | Actuator3 Temp | DEGF |
| | Temperature | | | | |
| 1007 | Box1 Voltage | VDC | 2007 | Sensor2 Volts | VDC |
| 1008 | Box1 Current | A | 2008 | Sensor2 Current | A |
| 1009 | System Current | A | 2009 | System2 Volts | Volt |
| 1010 | System Voltage | VDC | 2010 | System2 Current | AMPS |

Since there are very few rows in each database, it is a relatively simple task to combine the units, identify the unique units, and evaluate the unique units, as shown in Table 2.

TABLE 2
Unique Engineering Units from both databases

| Database 1 unique units | Database 2 unique units |
|---|---|
| Units | Units |
| A | A |
| DEGC | AMPS |
| DEGF | Deg F |
| PSIG | DEGF |
| VDC | DVC |
| WATTS | V |
| | VDC |
| | Volt |

A final units list has a single entry for each Unit from each database. The Units can then be examined and the data owners can decide on a common, unique set of Units that will be used in each database. Table 3 shows the resultant table and the Units as the Users require.

TABLE 3
Unique Units and how to change them

| Existing Units | Transform To |
|---|---|
| A | A |
| AMPS | A |
| Deg F | DEGF |
| DEGC | DEGC |
| DEGF | DEGF |
| DVC | VDC |
| PSIG | PSIG |
| V | VDC |
| VDC | VDC |
| Volt | VAC |
| WATTS | WATTS |

In Microsoft Excel, a unique list of items can be created using the “Advanced Filter” command.

At this point, the problems between the two databases have been identified and a solution proposed. In one specific application of the inductive data transformation method, the proposed solution is sent to the data owner for evaluation, and returned with any corrections. For purposes of example, it is assumed that the data owners have decided that they would rather see “AMPS” rather than “A”. Table 4 illustrates a table as revised from Table 3. Table 3 and Table 4 are sometimes individually referred to as a transformation matrix.

TABLE 4
Verified Transformation Matrix

| Existing Units | Transform To |
|---|---|
| A | A |
| AMPS | A |
| Deg F | DEGF |
| DEGC | DEGC |
| DEGF | DEGF |
| DVC | VDC |
| PSIG | PSIG |
| V | VDC |
| VDC | VDC |
| Volt | VAC |
| WATTS | WATTS |

As those skilled in the art will come to understand, a strategy is to update a units table and a measurement table in both databases. Changed units will have to be updated in both databases and units that do not exist in a database will have to be added. In one embodiment, these changes are accomplished by performing a series of look-ups to identify the changed units in the transformation matrix. SQL statements are then created directly from the spreadsheet data.

First the Units Table in database 1 is updated using a spreadsheet with the unique units from the previous analysis. Added to the spreadsheet is a column that will look up any changed units and provide a side-by-side transformation required specifically for database 1. In a specific embodiment, the formula in the “transform to” column in Table 4 makes use of the “VLOOKUP” function in Excel. For example,

=VLOOKUP(A2,‘[Units Transformation matrix.xls]Sheet1’!$A$2:$B$12,2,FALSE), where A2 is the original unit (“A”), and the lookup range is the transformation matrix in Table 4.

The Excel VLOOKUP command is extremely useful in bringing missing or new data into a spreadsheet. It is also a command that takes some time for Excel to calculate, especially when looking up large amounts of data in a large look-up table.

Using the FILL DOWN command calculates the transformations that will be required to change the existing units to match the approved units in the transformation matrix of Table 4. In the case of database 1, and referring to the above Tables, only a single change needs to be made, where the “A” will be changed to the approved value of “AMPS”, as shown in Table 5.

TABLE 5
Units Changes in Database 1

| Units | Transform To |
|---|---|
| A | AMPS |
| DEGC | DEGC |
| DEGF | DEGF |
| PSIG | PSIG |
| VDC | VDC |
| WATTS | WATTS |

Continuing, a SQL statement is created in the column to the right of the “Transform To” column. The formula is utilized to create a Microsoft Excel cell value that, when calculated, will display a perfectly-formed SQL statement that will be used to make the desired database change for a single row. In an embodiment, the formula is put together utilizing an IF statement that will leave the cell blank if no change needs to be made, leaving only the lines of SQL needed for the update. Specifically,

=IF(A2<>B2,“update UNITS_TABLE set UNITS=“‘&B2&’” where UNITS=“‘&A2&’”;“,””) is one example.

The “Fill Down” command is utilized to add the formulas to the subsequent units and the spreadsheet shown in Table 6 results.

TABLE 6
SQL Update for Database 1 Unit changes

| A | B | C |
|---|---|---|
| Units | Transform To | Units SQL |
| A | AMPS | update UNITS_TABLE set |
| | | UNITS = ‘AMPS’ where |
| | | UNITS = ‘A’; |
| DEGC | DEGC | |
| DEGF | DEGF | |
| PSIG | PSIG | |
| VDC | VDC | |
| WATTS | WATTS | |

In most production databases there is an audit table that keeps close track of the changes made to the data. Many times the programming that supports the tracking of changes is built directly into the user interface. Since the herein described embodiments are making changes directly into the database, that is without going through the user interface, or front end, such changes might easily be lost or go undocumented. However, in a specific embodiment, specific audit records are written for each change that is made. The formula will be entered into the next column to the right and has an appearance similar to the following example:

=IF(A2< >B2,“insert into Audit_Recs (Column_Name, Key,
Change_Reason, User, Date) values (“‘&A$1&’”, “‘&A2&’”,
‘Unit Consolidation with Database 2, changed unit “&A2&” to “&B2&”’,
user, sysdate);”,“”)

The fill down command will create a spreadsheet entry with the changes required to update the existing units to match the approved list, as desired, and as shown in Table 7.

TABLE 7
SQL Update and Audit for Database 1

| | B | | |
|---|---|---|---|
| A | Transform | C | D |
| Units | To | Units SQL | Audit SQL |
| A | AMPS | update | insert into Audit_Recs |
| | | UNITS_TABLE set | (Column_Name, Key, |
| | | UNITS = ‘AMPS’ | Change_Reason, User, |
| | | where UNITS = ‘A’; | Date) values (‘Units’, |
| | | | ‘A’, ‘Unit |
| | | | Consolidation with |
| | | | Database 2, changed |
| | | | unit A to AMPS’, user, |
| | | | sysdate); |
| DEGC | DEGC | | |
| DEGF | DEGF | | |
| PSIG | PSIG | | |
| VDC | VDC | | |
| WATTS | WATTS | | |

An additional and important column is then added where the combination of the update and the audit will reside. Specifically, the following formula is one example of a formula that can be added into Column E of the spreadsheet: =IF(A2<>B2,C2&CHAR(13)&D2,“”).

By filling down that formula following data will be added to the spreadsheet, as shown in Table 8:

TABLE 8
Completed Update SQL for Database 1

| | B | | | |
|---|---|---|---|---|
| A | Transform | C | D | E |
| Units | To | Units SQL | Audit SQL | Combo |
| A | AMPS | update | insert into | update |
| | | UNITS_TABLE | Audit_Recs | UNITS_TABLE set |
| | | set UNITS = ‘AMPS’ | (Column_Name, | UNITS = ‘AMPS’ |
| | | where | Key, | where UNITS = ‘A’; |
| | | UNITS = ‘A’; | Change_Reason, | insert into Audit_Recs |
| | | | User, Date) values | (Column_Name Key, |
| | | | (‘Units’, ‘A’, ‘Unit | Change_Reason, User, |
| | | | Consolidation with | Date) values (‘Units’, |
| | | | Database 2, | ‘A’, ‘Unit |
| | | | changed unit A to | Consolidation with |
| | | | AMPS’, user, | Database 2, changed |
| | | | sysdate); | unit A to AMPS’, user, |
| | | | | sysdate); |
| DEGC | DEGC | | | |
| DEGF | DEGF | | | |
| PSIG | PSIG | | | |
| VDC | VDC | | | |
| WATTS | WATTS | | | |

It may seem unnecessary to create a combination column since all the SQL is already written and can be copied and pasted. However, the Combo column makes each individual change stand-alone, and allows the testing of a single thorough change in a database. By copying any cell in the Combo column the analyst can immediately run the SQL and evaluate the full impact of any individual unit change.

The same technique is applied to the unit table of database 2 unit table and the following result is obtained, as illustrated by Table 9. Since the tables are designed to be similar (having similar table names, number of columns, and sharing the same transformation matrix), the careful spreadsheet navigator can copy the headers and formulas from rows 1 and 2 and paste them into the corresponding columns in the database 2 units spreadsheet. Simply utilize the “fill down” command and the updates are automatically written, saving time and reducing human error.

TABLE 9
Completed Update SQL for Database 2

| | B | | | |
|---|---|---|---|---|
| A | Transform | C | D | E |
| Units | To | Units SQL | Audit SQL | Combo |
| A | AMPS | update | insert into | update |
| | | UNITS_TABLE set | Audit_Recs | UNITS_TABLE set |
| | | UNITS = ‘AMPS’ | (Column_Name, | UNITS = ‘AMPS’ |
| | | where UNITS = ‘A’; | Key, | where UNITS = ‘A’; |
| | | | Change_Reason, | insert into Audit_Recs |
| | | | User, Date) values | (Column_Name, Key, |
| | | | (‘Units’, ‘A’, ‘Unit | Change_Reason, User, |
| | | | Consolidation with | Date) values (‘Units’, |
| | | | Database 2, | ‘A’, ‘Unit Consolidation |
| | | | changed unit A to | with Database 2, |
| | | | AMPS’, user, | changed unit A to |
| | | | sysdate); | AMPS’, user, sysdate); |
| AMPS | AMPS | | | |
| Deg F | DEGF | update | insert into | update |
| | | UNITS_TABLE set | Audit_Recs | UNITS_TABLE set |
| | | UNITS = ‘DEGF’ | (Column_Name, | UNITS = ‘DEGF’ |
| | | where UNITS = ‘Deg | Key, | where UNITS = ‘Deg |
| | | F’; | Change_Reason, | F’; |
| | | | User, Date) values | insert into Audit_Recs |
| | | | (‘Units’, ‘Deg F’, | (Column_Name, Key, |
| | | | ‘Unit Consolidation | Change_Reason, User, |
| | | | with Database 2, | Date) values (‘Units’, |
| | | | changed unit Deg F | ‘Deg F’, ‘Unit |
| | | | to DEGF’, user, | Consolidation with |
| | | | sysdate); | Database 2, changed |
| | | | | unit Deg F to DEGF’, |
| | | | | user, sysdate); |
| DEGF | DEGF | | | |
| DVC | VDC | update | insert into | update |
| | | UNITS_TABLE set | Audit_Recs | UNITS_TABLE set |
| | | UNITS = ‘VDC’ | (Column Name, | UNITS = ‘VDC’ where |
| | | where UNITS = ‘DVC’; | Key, | UNITS = ‘DVC’; |
| | | | Change_Reason, | insert into Audit_Recs |
| | | | User, Date) values | (Column_Name, Key, |
| | | | (‘Units’, ‘DVC’, | Change_Reason, User, |
| | | | ‘Unit Consolidation | Date) values (‘Units’, |
| | | | with Database 2, | ‘DVC’, ‘Unit |
| | | | changed unit DVC | Consolidation with |
| | | | to VDC’, user, | Database 2, changed |
| | | | sysdate); | unit DVC to VDC’, |
| | | | | user, sysdate); |
| V | VDC | update | insert into | update |
| | | UNITS_TABLE set | Audit_Recs | UNITS_TABLE set |
| | | UNITS = ‘VDC’ | (Column_Name, | UNITS = ‘VDC’ where |
| | | where UNITS = ‘V’; | Key, | UNITS = ‘V’; |
| | | | Change_Reason, | insert into Audit_Recs |
| | | | User, Date) values | (Column_Name, Key, |
| | | | (‘Units’, ‘V’, ‘Unit | Change_Reason, User, |
| | | | Consolidation with | Date) values (‘Units’, |
| | | | Database 2, | ‘V’, ‘Unit Consolidation |
| | | | changed unit V to | with Database 2, |
| | | | VDC’, user, | changed unit V to |
| | | | sysdate); | VDC’, user, sysdate); |
| VDC | VDC | | | |
| Volt | VAC | update | insert into | update |
| | | UNITS_TABLE set | Audit_Recs | UNITS_TABLE set |
| | | UNITS = ‘VAC’ | (Column_Name, | UNITS = ‘VAC’ where |
| | | where UNITS = ‘Volt’; | Key, | UNITS = ‘Volt’; |
| | | | Change_Reason, | insert into Audit_Recs |
| | | | User, Date) values | (Column_Name, Key, |
| | | | (‘Units’, ‘Volt’, | Change_Reason, User, |
| | | | ‘Unit Consolidation | Date) values (‘Units’, |
| | | | with Database 2, | ‘Volt’, ‘Unit |
| | | | changed unit Volt | Consolidation with |
| | | | to VAC’, user, | Database 2, changed |
| | | | sysdate); | unit Volt to VAC’, |
| | | | | user, sysdate); |

In an embodiment, if there are many rows being updated, the Combo formula can be enhanced to provide a “Commit;” command every 100 rows (relieving stress on the database's rollback segment) by using the following formula for the Combo column, specifically,

=IF(A2< >B2,C2&CHAR(13)&D2,″″)&IF(MOD(ROW(A2),100)=0,
IF(LEN(B2)>0, CHAR(13)&”Commit;”,“Commit;”),””)

The spreadsheets are then saved in their current form to preserve the formulas and to provide “objective evidence” of the changes that will be made. The Units SQL column is then copied from each spreadsheet into separate text files with an extension of “.sql”. By adding a “Commit;” statement at the end of each script, each of these SQL scripts can then be run on their appropriate databases to make the required changes. The blank lines are a result of having data that is already in the desired units. In such a case (e.g., VDC), since the data is already in the desired units, an update is not needed. These blank lines have no affect on the running of the SQL script, however, utilization of the Microsoft Excel data filter may provide a more professional look by removing the blank lines prior to copying them into a document.

One obvious advantage of the described methods is that the method requires the same small amount of work regardless of the number of changes being implemented. Because of the careful way the formulas are constructed, the method allows the “Fill Down” command to do most of the work, making enormous amounts of data fixes to be implemented with surgical precision.

The method also insulates the analyst from engineering changes. For example, if the data owners decide that the unit DEGC is incorrect throughout the system and should be changed to DEGF, the analyst simply goes into the transformation matrix, makes the update to the DEGC unit, and recalculates the spreadsheets. The Database 1 Unit update sheet automatically calculates a new row that will completely take care of the new change, as illustrated by Table 10.

TABLE 10
Database 1 SQL showing additional Unit change

| | B | | | |
|---|---|---|---|---|
| A | Transform | C | D | E |
| Units | To | Units SQL | Audit SQL | Combo |
| A | AMPS | update | insert into | update |
| | | UNITS_TABLE | Audit_Recs | UNITS_TABLE set |
| | | set UNITS = ‘AMPS’ | (Column_Name, | UNITS = ‘AMPS’ |
| | | where | Key, | where UNITS = ‘A’; |
| | | UNITS = ‘A’; | Change_Reason, | insert into Audit_Recs |
| | | | User, Date) values | (Column_Name, Key, |
| | | | (‘Units’, ‘A’, ‘Unit | Change_Reason, User, |
| | | | Consolidation with | Date) values (‘Units’, |
| | | | Database 2, | ‘A’, ‘Unit |
| | | | changed unit A to | Consolidation with |
| | | | AMPS’, user, | Database 2, changed |
| | | | sysdate); | unit A to AMPS’, user, |
| | | | | sysdate); |
| DEGC | DEGF | update | insert into | update |
| | | UNITS_TABLE | Audit_Recs | UNITS_TABLE set |
| | | set UNITS = ‘DEGF’ | (Column_Name, | UNITS = ‘DEGF’ |
| | | where | Key, | where UNITS = ‘DEGC’; |
| | | UNITS = ‘DEGC’; | Change_Reason, | insert into Audit_Recs |
| | | | User, Date) values | (Column_Name, Key, |
| | | | (‘Units’, ‘DEGC’, | Change_Reason, User, |
| | | | ‘Unit Consolidation | Date) values (‘Units’, |
| | | | with Database 2, | ‘DEGC’, ‘Unit |
| | | | changed unit | Consolidation with |
| | | | DEGC to DEGF’, | Database 2, changed |
| | | | user, sysdate); | unit DEGC to DEGF’, |
| | | | | user, sysdate); |
| DEGF | DEGF | | | |
| PSIG | PSIG | | | |
| VDC | VDC | | | |
| WATTS | WATTS | | | |

The Combo column is then copied, and pasted into a text document (e.g., a NotePad file), producing perfectly-formed SQL, ready to run, as illustrated below:

update UNITS_TABLE set UNITS = ‘AMPS’ where UNITS = ‘A’;
insert into Audit_Recs (Column_Name, Key, Change_Reason, User,
Date) values (‘Units’, ‘A’, ‘Unit Consolidation with Database 2,
changed unit A to AMPS’, user, sysdate);
update UNITS_TABLE set UNITS = ‘DEGF’ where UNITS = ‘DEGC’;
insert into Audit_Recs (Column_Name, Key, Change_Reason, User,
Date) values (‘Units’, ‘DEGC’, ‘Unit Consolidation with Database 2,
changed unit DEGC to DEGF’, user, sysdate);

Enhancements to the readability of the SQL are easily made by adding a carriage return character before the “where” and “values” keywords:

```
update UNITS_TABLE set UNITS = ‘AMPS’
  where UNITS = ‘A’;
insert into Audit_Recs (Column_Name, Key, Change_Reason, User,
  Date) values (‘Units’, ‘A’, ‘Unit Consolidation with Database 2,
changed unit A to AMPS’, user, sysdate);
update UNITS_TABLE set UNITS = ‘DEGF’
  where UNITS = ‘DEGC’;
insert into Audit_Recs (Column_Name, Key, Change_Reason,
  User, Date) values (‘Units’, ‘DEGC’, ‘Unit Consolidation with
Database 2, changed unit DEGC to DEGF’, user, sysdate);
```

An undo function is easily created by duplicating the last three columns (Units SQL, Audit SQL and Combo) and making some minor changes to the formula, for example, interchanging the old value column with the new. The new Audit record indicates that this is a reversal of a previous action, as illustrated in Table 11.

TABLE 11
Details of the “UNDO” SQL

| F | G | H |
|---|---|---|
| Units SQL | Audit SQL | Combo |
| update | insert into Audit_Recs | update |
| UNITS_TABLE | (Column_Name, Key, | UNITS_TABLE set |
| set UNITS = | Change_Reason, User, | UNITS = ‘A’ where |
| ‘A’ where | Date) values (‘Combo’, | UNITS = ‘AMPS’; |
| UNITS = | ‘AMPS’, ‘Unit | insert into Audit_Recs |
| ‘AMPS’; | Consolidation with | (Column_Name, Key, |
| | Database 2 REVERSED, | Change_Reason, User, |
| | changed unit AMPS back | Date) values (‘Combo’, |
| | to A’, user, sysdate); | ‘AMPS’, ‘Unit |
| | | Consolidation with |
| | | Database 2 |
| | | REVERSED, changed |
| | | unit AMPS back to A’, |
| | | user, sysdate); |

Because of the Combo column, the undo SQL creates a complete change transaction and has the flexibility of being able to be perform an undo for select individual rows or as a full undo.

Now the existing units in both databases match, and the Units that are missing from each database can be added so that future measurements can reference these added units. Returning to the Units Transformation Matrix spreadsheet, we add four new columns to the existing sheet: Database 1, SQL 1, Audit 1, and Combo 1. Entering the following formula to the Database 1 column, will result in a lookup being performed into the Database 1 units to see if there are any units from the Transformation Matrix that are missing:

=IF(ISNA(VLOOKUP($B2,‘[System1 Measurements and
Units.xls]Units’!$B$2:$B$7,1,FALSE)),“MISSING”,“”)

The result for Database 1 is a single missing unit: “VAC”, as shown in Table 12.

TABLE 12
Identifying Missing Unit in Database 1

| A | B | C |
|---|---|---|
| Existing Units | Transform To | Database 1 |
| A | AMPS | |
| AMPS | AMPS | |
| Deg F | DEGF | |
| DEGC | DEGF | |
| DEGF | DEGF | |
| DVC | VDC | |
| PSIG | PSIG | |
| V | VDC | |
| VDC | VDC | |
| Volt | VAC | MISSING |
| WATTS | WATTS | |

In the SQL1 column, the following formula will utilizes the word “MISSING” to trigger the generation of the SQL statement:

=IF(C2=“MISSING”,“insert into UNITS_TABLE (UNITS) values (“‘&$B2&’”);“,””)

TABLE 13
SQL to add missing Unit to Database 1

| A | B | C | D |
|---|---|---|---|
| Existing Units | Transform To | Database 1 | SQL 1 |
| A | AMPS | | |
| AMPS | AMPS | | |
| Deg F | DEGF | | |
| DEGC | DEGF | | |
| DEGF | DEGF | | |
| DVC | VDC | | |
| PSIG | PSIG | | |
| V | VDC | | |
| VDC | VDC | | |
| Volt | VAC | MISSING | insert into |
| | | | UNITS_TABLE |
| | | | (UNITS) values |
| | | | (‘VAC’); |
| WATTS | WATTS | | |

Similarly the word “Missing” will trigger the generation of the audit record and the combination column:

Cell E2: =IF(C2=“MISSING”,“insert into Audit_Recs (Column_Name,
Key, Change_Reason, User, Date) values (“‘&$A$1&’”, “‘&$A2&’”,
‘Unit Consolidation with Database 2, added unit “&$B2&”’, user,
sysdate);”,“”)
Cell F2: =IF(C2=“MISSING”,D2&CHAR(13)&E2,“”)

The final spreadsheet with the SQL to add the missing units to database 1 is in Table 14, below.

TABLE 14
Final SQL to add missing Unit to Database 1

| A | B | | | | |
|---|---|---|---|---|---|
| Existing | Transform | C | D | E | F |
| Units | To | Database 1 | SQL 1 | Audit 1 | Combo 1 |
| A | AMPS | | | | |
| AMPS | AMPS | | | | |
| Deg F | DEGF | | | | |
| DEGC | DEGF | | | | |
| DEGF | DEGF | | | | |
| DVC | VDC | | | | |
| PSIG | PSIG | | | | |
| V | VDC | | | | |
| VDC | VDC | | | | |
| Volt | VAC | MISSING | insert into | insert into | insert into |
| | | | UNITS_TABLE | Audit_Recs | UNITS_TABLE |
| | | | (UNITS) values | (Column_Name, | (UNITS) values |
| | | | (‘VAC’); | Key, | (‘VAC’); |
| | | | | Change_Reason, | insert into |
| | | | | User, Date) | Audit_Recs |
| | | | | values (‘Existing | (Column_Name, |
| | | | | Units’, ‘Volt’, | Key, |
| | | | | ‘Unit | Change_Reason, |
| | | | | Consolidation | User, Date) |
| | | | | with Database 2, | values (‘Existing |
| | | | | added unit VAC’, | Units’, ‘Volt’, |
| | | | | user, sysdate); | ‘Unit |
| | | | | | Consolidation |
| | | | | | with Database 2, |
| | | | | | added unit VAC’, |
| | | | | | user, sysdate); |
| WATTS | WATTS | | | | |

To generate the same information for database 2's missing units, copy columns C through F and paste into column G. Rename the columns to indicate database 2 and adjust the formulas to lookup database 2 information:

Cell G2: =IF(ISNA(VLOOKUP($B2,‘[System2 Measurements and
Units.xls]Units’!$B$2:$B$7,1,FALSE)),“MISSING”,“”)
Cell H2: =IF(G2=“MISSING”,“insert into UNITS_TABLE (UNITS)
values (“‘&$B2&’”);”,“”)
Cell I2: =IF(G2=“MISSING”,“insert into Audit_Recs (Column_Name,
Key, Change_Reason, User, Date) values (“‘&$A$1&’”,
“‘&$A2&’”, ‘Unit Consolidation with Database 2, added unit
“&$B2&”’, user, sysdate);”,“”)
Cell J2: =IF(G2=“MISSING”,H2&CHAR(13)&I2,“”)

Use the Fill Down function and the SQL is now complete for updating existing Units and inserting the ones that are missing (note that database 1 columns are hidden in the table).

TABLE 15
Final SQL to add missing Unit to Database 2

| A | B | | | | |
|---|---|---|---|---|---|
| Existing | Transform | G | H | I | J |
| Units | To | Database 2 | SQL 2 | Audit 2 | Combo 2 |
| A | AMPS | | | | |
| AMPS | AMPS | | | | |
| Deg F | DEGF | | | | |
| DEGC | DEGF | | | | |
| DEGF | DEGF | | | | |
| DVC | VDC | | | | |
| PSIG | PSIG | MISSING | insert into | insert into | insert into |
| | | | UNITS_TABLE | Audit_Recs | UNITS_TABLE |
| | | | (UNITS) values | (Column_Name, | (UNITS) values |
| | | | (‘PSIG’); | Key, | (‘PSIG’); |
| | | | | Change_Reason, | insert into |
| | | | | User, Date) | Audit_Recs |
| | | | | values (‘Existing | (Column_Name, |
| | | | | Units’, ‘PSIG’, | Key, |
| | | | | ‘Unit | Change_Reason, |
| | | | | Consolidation | User, Date) |
| | | | | with Database 2, | values (‘Existing |
| | | | | added unit | Units’, ‘PSIG’, |
| | | | | PSIG’, user, | ‘Unit |
| | | | | sysdate); | Consolidation |
| | | | | | with Database 2, |
| | | | | | added unit |
| | | | | | PSIG’, user, |
| | | | | | sysdate); |
| V | VDC | | | | |
| VDC | VDC | | | | |
| Volt | VAC | MISSING | insert into | insert into | insert into |
| | | | UNITS_TABLE | Audit_Recs | UNITS_TABLE |
| | | | (UNITS) values | (Column_Name, | (UNITS) values |
| | | | (‘VAC’); | Key, | (‘VAC’); |
| | | | | Change_Reason, | insert into |
| | | | | User, Date) | Audit_Recs |
| | | | | values (‘Existing | (Column_Name, |
| | | | | Units’, ‘Volt’, | Key, |
| | | | | ‘Unit | Change_Reason, |
| | | | | Consolidation | User, Date) |
| | | | | with Database 2, | values (‘Existing |
| | | | | added unit | Units’, ‘Volt’, |
| | | | | VAC’, user, | ‘Unit |
| | | | | sysdate); | Consolidation |
| | | | | | with Database 2, |
| | | | | | added unit |
| | | | | | VAC’, user, |
| | | | | | sysdate); |
| WATTS | WATTS | MISSING | insert into | insert into | insert into |
| | | | UNITS_TABLE | Audit_Recs | UNITS_TABLE |
| | | | (UNITS) values | (Column_Name, | (UNITS) values |
| | | | (‘WATTS’); | Key, | (‘WATTS’); |
| | | | | Change_Reason, | insert into |
| | | | | User, Date) | Audit_Recs |
| | | | | values (‘Existing | (Column_Name, |
| | | | | Units’, | Key, |
| | | | | ‘WATTS’, ‘Unit | Change_Reason, |
| | | | | Consolidation | User, Date) |
| | | | | with Database 2, | values (‘Existing |
| | | | | added unit | Units’, |
| | | | | WATTS’, user, | ‘WATTS’, ‘Unit |
| | | | | sysdate); | Consolidation |
| | | | | | with Database 2, |
| | | | | | added unit |
| | | | | | WATTS’, user, |
| | | | | | sysdate); |

Copy the Combo columns for each database and append it to the previous SQL script files. Add a “Commit;” at the end of each. Now that the Units tables are both updated correctly, the Measurements themselves must be updated to reference the transformed Units.

In summary, the above described methods for inductive data transformation result in the creation of one or more change scripts for data which is then applied to the database. The change scripts are based on data analyzed and managed within a spreadsheet. As the data is reviewed and corrected within the spreadsheet, formulas utilized to populate database and/or spreadsheet are recalculated to create the proper SQL statement to be run to carry out the changes within the database. Each individual change is small, for example, a single row in a single table at a time. By categorizing the nature of the individual changes, a user is able to use one or more commands in the spreadsheet program to produce the specific SQL statements for as many rows of changes as are needed, with no extra effort and no expensive programming.

Multiple benefits are realized by users of the above described embodiments of inductive data transformation. For example, an analysis of a data problem leads directly to a solution for the data problem. Another benefit is that the use of common tools facilitates verification of solutions by management, information technology personnel, database administrators, and users alike, resulting in less risk and a greater success rate.

The inductive data transformation method also leaves objective evidence of each individual change. As a result, there are no unknowns, and users are able to see exactly what changes and/or updates have been performed. As was described above, another benefit is that data fixes can be undone or corrected immediately and selectively. Missing data or data that exists in separate, multiple sources (such as multiple tables or spreadsheets) is easily consolidated and incorporated.

The inductive data transformation method is flexible and can address many common data issues, such as moving data from one database to another, making mass updates to existing records, complex multi-table inserts and updates. The method is also scalable and quickly implemented, and can be used effectively whether there are ten or ten million data changes to be made. As described above, the inductive data transformation method is self-documenting and reusable, that is, future data changes of a similar nature can be immediately made with little effort.

Database data will be consistently improving and growing in value because the information in the database keeps increasing in accuracy and completeness.

While the invention has been described in terms of various specific embodiments, those skilled in the art will recognize that the invention can be practiced with modification within the spirit and scope of the claims.

What is claimed is:

1. A method for updating data within a database, said method comprising:
identifying data elements within the database that need to be updated;
creating a data transformation matrix for analysis of proposed changes to the data elements;
creating a database update script including an update command for each group of proposed changes; and
running the database update script to update the database.

2. The method according to claim 1, wherein identifying data elements that need to be updated comprises identifying the nature of the needed data changes, identifying data types associated with the changes, and categorizing the needed data changes.

3. The method according to claim 2, wherein creating a data transformation matrix for analysis of proposed changes comprises:
determining material changes to be made for each data change category; and
managing change audit records.

4. The method according to claim 1, wherein creating a data transformation matrix for analysis of proposed changes comprises creating the data transformation matrix utilizing spreadsheet manipulations.

5. The method according to claim 4, wherein creating a database update script comprises creating, directly from data within the spreadsheet, a structured query language data update command for each group of proposed changes.

6. The method according to claim 5, wherein creating a structured query language data update command for each group of proposed changes comprises replicating the structured query language update command for each data element in the change group based on data in said transformation matrix.

7. The method according to claim 5, wherein creating, directly from data within the spreadsheet, a structured query language data update command for each group of proposed changes comprises creating a cell value that, when calculated, results in a structured query language statement operable to make desired data element changes for a single row of the database.

8. The method according to claim 5, wherein creating a structured query language data update command for each group of proposed changes comprises creating a corresponding structured query language undo data change command operable to undo the corresponding changes made to the database.

9. The method according to claim 8, wherein creating a corresponding structured query language undo data change command comprises creating a structured query language undo data changes script by compiling the structured query language undo data change commands.

10. The method according to claim 1, further comprising recording changes made to the database.

11. The method according to claim 10, wherein recording changes made to the database comprises running a corresponding structured query language audit update command after running each structured query language data update command.

12. A computer system programmed to:
compile a matrix of proposed changes to data elements of a database;
create a database update script, directly from data within the database, including an update command for each group of proposed changes; and
run the database update script to update the data elements in the database.

13. The computer system according to claim 12, wherein to create a database update script said computer is programmed to create a structured query language data update command for each group of data elements to be updated within the database.

14. The computer system according to claim 13, further programmed to replicate the structured query language update command for each data element in the group of data elements to be updated within the database.

15. The computer system according to claim 13, further programmed to create a cell value for a database spreadsheet that, when calculated, results in a structured query language statement operable to update database data elements for a single row of the database.

16. The computer system according to claim 13, further programmed to create a corresponding structured query language undo data element change command operable to remove corresponding database data elements updates made to the database.

17. The computer system according to claim 12, further programmed to running a corresponding audit update command script after running each database update script.

18. A method for generating a script for updating data within a database, said method comprising:
manipulating elements within a spreadsheet associated with the database to create a data transformation matrix;
creating, directly from data within the spreadsheet, a structured query language (SQL) data update command for updating the data within the database; and
executing the SQL data update command.

19. The method according to claim 18, wherein creating a SQL data update command comprises replicating the SQL update command for each data element in the database to be updated.

20. The method according to claim 18, wherein creating a SQL data update command comprises creating a cell value for the spreadsheet that, when calculated, results in a SQL statement operable to update data elements within a single row of the database.

21. The method according to claim 18, wherein creating a SQL data update command for updating the data within the database comprises creating a corresponding SQL undo data change command operable to undo the updates to the data within the database.
